(19) United States
(12) Patent Application Publication
(10) Pub. No.: US 2013/0048459 A1
(43) Pub. Date: Feb. 28, 2013

(54) LOCK-UP DEVICE FOR TORQUE CONVERTER

(71) Applicant: Yoshihiro Matsuoka, Neyagawa-shi (JP)

(72) Inventor: Yoshihiro Matsuoka, Neyagawa-shi (JP)

(73) Assignee: EXEDY CORPORATION, Neyagawa-shi, Osaka (JP)

(21) Appl. No.: 13/696,542

(22) PCT Filed: May 17, 2011
(86) PCT No.: PCT/JP2011/061325

§ 371 Date: Nov. 6, 2012

(30) Foreign Application Priority Data
Jun. 4, 2010 (JP) 2010-128650

(51) Int. Cl. F16D 3/66

(52) U.S. Cl. 192/55.6

(57) ABSTRACT

A lock-up device for a torque converter is provided whereby vibration attributed to coil springs can be reliably inhibited. In the lock-up device, two large coil springs of each pair are disposed in series. Stiffness ratios α1 and α2 between an N-th torsional stiffness and an (N+1)-th torsional stiffness are set to be greater than or equal to 1.5 and less than or equal to 3.0 (N is positive integer) in a multistage torsional characteristic produced by compressing at least one of the two large coil springs of each pair and a small coil spring in accordance with a relative angle between an input rotary member and an output rotary member.

### CROSS-REFERENCE TO RELATED APPLICATIONS

This U.S. national phase application claims priority to Japanese Patent Application No. 2010-128650 filed on Jun. 4, 2010. The entire disclosure of Japanese Patent Application No. 2010-128650 is hereby incorporated herein by reference.

### TECHNICAL FIELD

The present invention relates to a lock-up device, particularly to a lock-up device for a torque converter to transmit torque, and simultaneously, absorb and attenuate torsional vibration.

### BACKGROUND ART

In many instances, torque converters include a lock-up device for directly transmitting torque from a front cover to a turbine. The lock-up device includes a piston, a retaining plate, a plurality of pairs of torsion springs and a driven plate. The piston can be frictionally coupled to the front cover. The retaining plate is fixed to the piston. The torsion springs are supported by the retaining plate. The driven plate is elastically coupled to the piston through the torsion springs in a rotational direction. The driven plate is fixed to the turbine (see Patent Literature 1).

The piston herein axially divides the space between the front cover and the turbine. Torque of the front cover is configured to be transmitted to the lock-up device when a friction facing annularly attached to the outer peripheral part of the piston is pressed onto a friction surface of the front cover. Accordingly, torque is transmitted from the lock-up device to the turbine. Fluctuation in torque to be inputted from an engine is herein absorbed and attenuated by a plurality of torsion springs disposed in the outer peripheral part of the lock-up device.

### CITATION LIST

### Patent Literature

PTL 1: Japan Laid-open Patent Application Publication No. JP-A-2008-138797

### SUMMARY

### Technical Problems

In the lock-up device described in Patent Literature 1 (hereinafter referred to as a well-known lock-up device), when the torsion springs of the plural pairs are compressed, the torsional characteristics of the torsion springs of the plural pairs are determined based on the torsional characteristic of the torsion springs of a single pair. In other words, it is required to set the torsional characteristic of the torsion springs of the single pair for determining the torsional characteristics of the torsion springs of the plural pairs.

A torsional characteristic indicates a relation between the torsional angle (the rotational angle) of the torsion springs of the single pair and the torque fluctuation amount that can be attenuated by the torsion springs of the single pair. Therefore, when the torsion springs of the single pair are compressed, torque fluctuation corresponding to the torsional stiffness of the torsion springs of the single pair is attenuated.

The well-known lock-up device has had a linear (one-stage) torsional characteristic. Therefore, it has been inevitable to increase torsional stiffness in order to attenuate predetermined torque fluctuation using the torsional characteristic. In this case, however, torsional stiffness becomes too large, and initial vibration, generated in starting the compression of the torsion springs, can be generated. Thus, a configuration of setting the torsional characteristic to be a bilinear (two-stage) type was devised for solving the aforementioned drawback. However, when the target attenuation amount with respect to torque fluctuation is set to be large, it is required to set a second torsional stiffness to be large for reliably achieving the target attenuation amount, although initial vibration can be inhibited. Therefore, a ratio of the second torsional stiffness with respect to the first torsional stiffness is herein increased. Accordingly, vibration attributed to difference in stiffness can be generated anew in a range of torsional characteristic greater than or equal to its bent point. In other words, even in setting the torsional characteristic to be the bilinear (two-stage) type, a drawback has been produced that vibration attributed to the torsion springs could not be completely inhibited.

The present invention has been produced in view of the aforementioned drawback. It is an object of the present invention to provide a lock-up device for a torque converter whereby vibration attributed to a coil spring can be reliably inhibited.

### Solution to Problems

A lock-up device for a torque converter according to claim 1 is a device for transmitting torque and for absorbing and attenuating torsional vibration. The lock-up device includes an input rotary member, an output rotary member, a plurality of pairs of first coil springs and a plurality of second coil springs.

The plural pairs of first coil springs are configured to be rotation-directionally compressed on a radially outer side by relative rotation between the input rotary member and the output rotary member. The two first coil springs of each pair are disposed in series. The plural second coil springs are configured to be rotation-directionally compressed on a radially inner side by the relative rotation between the inner rotary member and the outer rotary member at a predetermined relative angle or greater. In the lock-up device having such structure, a multistage torsional characteristic, which represents a relation between the torque and the relative angle between the input rotary member and the output rotary member, is produced by compressing at least any one of the two first coil springs of each pair and the second coil springs in accordance with the relative angle between the input rotary member and the output rotary member. Further, in the multistage torsional characteristic, a stiffness ratio between an N-th torsional stiffness and an (N+1)-th torsional stiffness is set to be greater than or equal to 1.5 and less than or equal to 3.0 (N is a positive integer).

In the present lock-up device, the torque of the engine is transmitted from the input rotary member to the output rotary member. At least any one of the first coil springs of each pair and the plural second coil springs is herein compressed by the relative rotation between the input rotary member and the output rotary member, and torsional vibration is absorbed and attenuated based on the multistage torsional characteristic in accordance with the relative angle. Especially, in the present lock-up device, the stiffness ratio between the N-th torsional stiffness and the (N+1)-th torsional stiffness (i.e., a stiffness ratio of the (N+1)-th torsional stiffness to the N-th torsional stiffness) is set to be greater than or equal to 1.5 and less than or equal to 3.0.

In the present invention, the torsional stiffness is set to have multi stages. Therefore, initial vibration attributed to the coil springs can be inhibited even when the target attenuation amount of torque variation is increased. Further, in the present invention, the stiffness ratio between the N-th torsional stiffness and the (N+1)-th torsional stiffness is set to be greater than or equal to 1.5 and less than or equal to 3.0. Therefore, it is possible to inhibit vibration that could be generated when a bent point of the torsional stiffness is exceeded, i.e., vibration attributed to difference in stiffness. Thus, in the present invention, vibration attributed to the coil springs can be reliably inhibited.

When explained in detail, stiffness difference between the N-th torsional stiffness and the (N+1)-th torsional stiffness becomes too small where the stiffness ratio between the N-th torsional stiffness and the (N+1)-th torsional stiffness becomes less than 1.5. Therefore, the number of stages of the torsional characteristic, required for reliably achieving the target attenuation amount, i.e., the number of stages of torsional characteristic in the regular use range is increased. Accordingly, chances are that setting or controlling of the torsional characteristic becomes difficult. Further, when the number of stages of the torsional characteristic is increased, chances are that the structure of the lock-up device becomes complicate. In this case, chances are that the cost of the lock-up device is increased. However, the present invention can solve such drawbacks.

Further, when the stiffness ratio between the N-th torsional stiffness and the (N+1)-th torsional stiffness becomes greater than 3.0, the stiffness difference between the N-th torsional stiffness and the (N+1)-th torsional stiffness becomes too large. Therefore, vibration attributed to the aforementioned stiffness difference can be produced when the N-th torsional stiffness is shifted to the (N+1)-th torsional stiffness. However, the present invention can solve such drawback.

A lock-up device for a torque converter according to claim 2 relates to the device of claim 1, and wherein the stiffness ratio between the N-th torsional stiffness and the (N+1)-th torsional stiffness in the torsional characteristic is set to be greater than or equal to 2.0 and less than or equal to 2.5. In this case, the stiffness ratio between the N-th torsional stiffness and the (N+1)-th torsional stiffness (the stiffness ratio of the (N+1)-th torsional stiffness with respect to the N-th torsional stiffness) is set to be greater than or equal to 2.0 and less than or equal to 2.5. Therefore, it is possible to reliably inhibit vibration attributed to the stiffness difference that could be produced when a bent point of the torsional characteristic is exceeded.

A lock-up device for a torque converter according to claim 3 relates to the device recited in claim 1 or claim 2, and wherein in the multistage torsional characteristic excluding the final stage of the torsional characteristic, a stiffness ratio between the N-th torsional stiffness and the (N+1)-th torsional stiffness is set to be the aforementioned stiffness ratio. In this case, where the multistage torsional characteristic excluding the final stage of the torsional characteristic is set as the torsional characteristic to be used in the regular use range, it is herein possible to inhibit vibration that could be generated when a bent point of the torsional characteristic is exceeded, i.e., vibration attributed to the stiffness difference, when the stiffness ratio between the N-th torsional stiffness and the (N+1)-th torsional stiffness in the regular use range is set to be greater than or equal to 1.5 and less than or equal to 3.0. Further, when the stiffness ratio is set to be greater than or equal to 2.0 and less than or equal to 2.5, it is possible to reliably inhibit vibration attributed to the stiffness difference that could be generated when a bent point of the torsional characteristic is exceeded.

A lock-up device for a torque converter according to claim 4 relates to the device recited in claim 3, and wherein the multistage torsional characteristic is a three stage torsional characteristic. In this case, compression of the two first coil springs of each pair is firstly started when the input rotary member and the output rotary member are rotated relatively to each other. Accordingly, torsional vibration is absorbed and attenuated in accordance with the torsional stiffness of the two first coil springs of each pair. Next, when any one of the two first coil springs of each pair is compressed while the coiled portions thereof are closely contacted to each other, whereas the other of the two first coil springs of each pair is compressed, torsional vibration is absorbed and attenuated in accordance with the torsional stiffness of the first coil spring herein compressed. Finally, when the other of the two first coil springs of each pair and the plural second coil springs are compressed, torsional vibration is absorbed and attenuated in accordance with the torsional stiffness of the first coil spring herein compressed and that of the second coil springs.

In the lock-up device having such torsional characteristic, the aforementioned stiffness ratio is set as a ratio between the first torsional stiffness produced when the two first coil springs of each pair are compressed and the second torsional stiffness produced when any one of the two first coil springs of each pair is compressed while the coiled portions thereof are closely contacted to each other whereas the other of the two first coil springs of each pair is compressed.

Thus, in the present invention, the second torsional stiffness is produced by compressing any one of the two first coil springs of each pair, with the coiled portions thereof being closely contacted to each other. Subsequently, the third torsional stiffness is produced by compressing the other of the two first coil springs of each pair and the second coil springs. Accordingly, a three stage torsional characteristic can be obtained without particularly preparing additional coil springs different from the first coil springs and the second coil springs. In other words, the three stage torsional characteristic can be easily obtained without complicating the lock-up device.

Further, in this case, where the multistage torsional characteristic excluding the third stage of the torsional characteristic (i.e., the first stage and the second stage of the torsional characteristic) is set as the torsional characteristic to be used in the regular use range, it is herein possible to inhibit vibration that could be generated when a bent point of the torsional characteristic is exceeded, i.e., vibration attributed to the stiffness difference, when the stiffness ratio between the first torsional stiffness and the second torsional stiffness in the regular use range is set to be greater than or equal to 1.5 and less than or equal to 3.0. Further, when the stiffness ratio is set to be greater than or equal to 2.0 and less than or equal to 2.5, it is possible to reliably inhibit vibration attributed to the stiffness difference that could be generated when a bent point of the torsional characteristic is exceeded.

A lock-up device for a torque converter according to claim 5 relates to the device recited in claim 4, and wherein a relative angle, produced when any one of the two first coil springs of each pair is compressed while the coiled portions thereof are closely contacted to each other, is less than a predetermined relative angle (the relative angle in claim 1) produced when compression of the second coil springs is started.

A third torsional stiffness is herein produced by setting the relative angle, produced when any one of the two first coil springs of each pair is compressed while the coiled portions thereof are closely contacted to each other, to be less than the predetermined relative angle produced when compression of the second coil springs is started. Accordingly, the three stage torsional characteristic can be easily obtained without particularly preparing additional coil springs different from the aforementioned first coil springs and second coil springs.

A lock-up device for a torque converter according to claim 6 relates to the device recited in any of claims 1 to 5, and further includes rotation restricting means for restricting the relative rotation between the input rotary member and the output rotary member.

In this case, the relative rotation between the input rotary member and the output rotary member is restricted by the rotation restricting means. Accordingly, the action of absorbing and attenuating torsional vibration (damper action) by the first coil springs and the second coil springs is stopped. In other words, the upper limit of the torsional characteristic is set by the rotation restricting means. Thus, with the setting of the upper limit of the torsional characteristic by the rotation restricting means, it is possible to reliably transmit torque from the input rotary member to the output rotary member when the torsional angle becomes greater than or equal to a predetermined angle.

### Advantageous Effects of Invention

According to the present invention, vibration attributed to a coil spring can be reliably inhibited in a lock-up device for a torque converter.

### BRIEF DESCRIPTION OF THE DRAWINGS

FIG. 1 is a schematic vertical cross-sectional view of a torque converter in which an exemplary embodiment of the present invention is employed.

FIG. 2 is a plan view of a lock-up device seen from a transmission side.

FIG. 3 is a diagram of an A-A′ cross-section in FIG. 2.

FIG. 4 is a diagram of an O-D cross-section in FIG. 2.

FIG. 5 is a plan view of a retaining plate.

FIG. 6 is a model diagram representing a three stage torsional characteristic of the lock-up device.

FIG. 7 includes model diagrams of the lock-up device in actuating torsion springs.

### DETAILED DESCRIPTION OF THE PREFERRED EMBODIMENTS

[Basic Structure of Torque Converter]

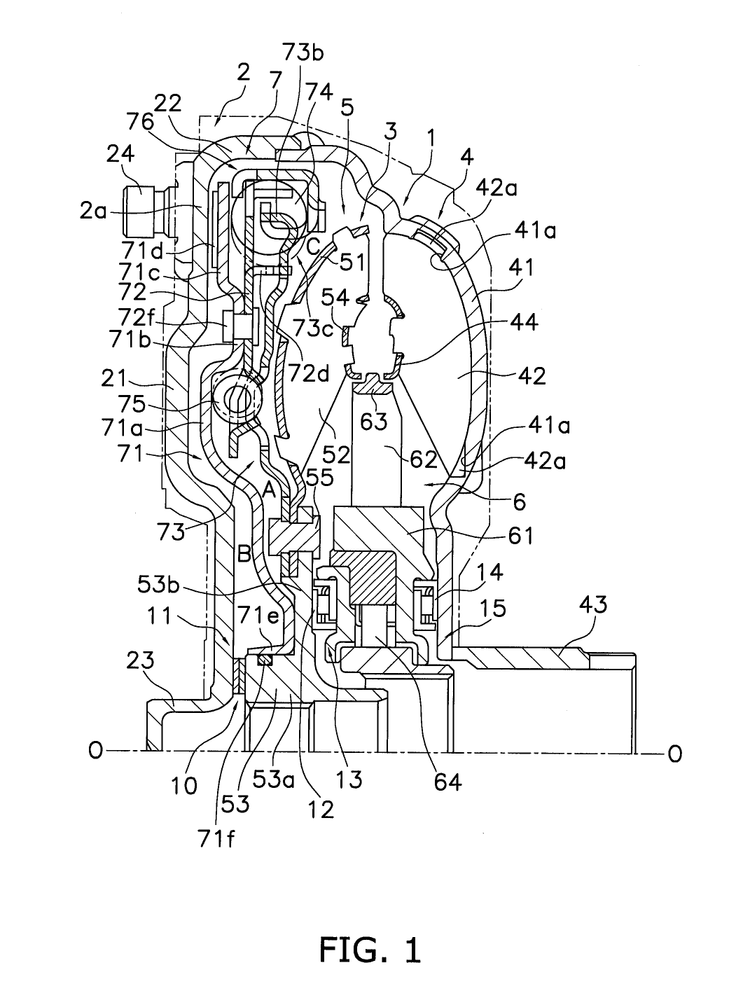

FIG. 1 is a schematic vertical cross-sectional view of a torque converter 1 (a fluid-type torque transmission device) in which an exemplary embodiment of the present invention is employed. The torque converter 1 is a device for transmitting torque from a crankshaft of an engine to an input shaft of a transmission. The engine (not illustrated in the figures) is disposed on the left side in FIG. 1, whereas the transmission (not illustrated in the figures) is disposed on the right side in FIG. 1. A line O-O depicted in FIG. 1 is the rotary axis of the torque converter 1.

The torque converter 1 includes a front cover 2, an impeller 4, a turbine 5, a stator 6 and a lock-up device 7. Further, the impeller 4, the turbine 5 and the stator 6 form a torus-shaped fluid actuation chamber 3.

The front cover 2 is a member to which torque is inputted through a flexible plate (not illustrated in the figures). The front cover 2 is a member disposed on the engine side and has an annular portion and a cylindrical portion 22 that is extended towards the transmission from the outer peripheral edge of the annular portion 21.

The front cover 2 includes a center boss 23 disposed on the inner peripheral end thereof. The center boss 23 is a cylindrical member axially extended, and is inserted into a center hole of the crankshaft.

Further, the flexible plate (not illustrated in the figures) is fixed to the engine side of the front cover 2 by a plurality of bolts 24. The flexible plate is a thin disc-shaped member for transmitting torque and for absorbing bending vibration to be transmitted from the crankshaft to the main body of the torque converter 1.

Further, the transmission side tip of the cylindrical portion 22 formed on the outer peripheral edge of the annular portion 21 is connected to the outer peripheral edge of an impeller shell 41 of the impeller 4 by welding. The front cover 2 and the impeller 4 form a fluid chamber that the inside thereof is filled with operating oil.

The impeller 4 mainly includes the impeller shell 41, impeller blades 42 fixed to the inside of the impeller shell 41, and an impeller hub 43 fixed to the inner peripheral part of the impeller shell 41.

The impeller shell 41 is disposed on the transmission side of the front cover 2 while being opposed to the front cover 2. The impeller shell 41 has fixation recessed portions 41a on the inner peripheral side surface thereof for fixing thereto the impeller blades 42. The impeller blades 42 are plate-shaped members to be pressed by the operating oil. The impeller blade 42 has convex portions 42a formed on the inner and outer peripheral side parts thereof for allowing them to be disposed in the fixation recessed portions 41a of the impeller shell 41. Further, an annular impeller core 44 is disposed on the turbine 5 side of the impeller blades 42. The impeller hub 43 is a tubular member extended towards the transmission from the inner peripheral end of the impeller shell 41.

The turbine 5 is disposed within the fluid chamber while being axially opposed to the impeller 4. The turbine 5 mainly includes a turbine shell 51, a plurality of turbine blades 52 and a turbine hub 53 fixed to the inner peripheral part of the turbine shell 51. The turbine shell 51 is a roughly disc-shaped member. The turbine blades 52 are plate-shaped members fixed to the impeller 4 side surface of the turbine shell 51. A turbine core 54 is disposed on the impeller 4 side of the turbine blades 52 while being opposed to the impeller core 44.

The turbine hub 53 is disposed in the inner peripheral part of the turbine shell 51 and has a cylindrical portion 53a axially extended and a disc portion 53b extended to the outer peripheral side from the cylindrical portion 53a. The inner peripheral part of the turbine shell 51 is fixed to the disc portion 53b of the turbine hub 53 by a plurality of rivets 55. Further, a spline to be engaged with the input shaft is formed on the inner peripheral part of the cylindrical portion 53a of the turbine hub 53. The turbine hub 53 is thereby unitarily rotated with the input shaft.

The stator 6 is a mechanism for regulating the flow of the operating oil returning from the turbine 5 to the impeller 4. The stator 6 is a member integrally fabricated by forging of resin, aluminum alloy or etc. The stator 6 mainly includes an annular stator carrier 61, a plurality of stator blades 62 disposed on the outer peripheral surface of the stator carrier 61, and a stator core 63 disposed on the outer peripheral side of the stator blades 62. The stator carrier 61 is supported by a tubular fixation shaft (not illustrated in the figures) through a one-way clutch 64.

The impeller shell 41, the turbine shell 51 and the stator carrier 61, described above, form the torus-shaped fluid actuation chamber 3 within the fluid chamber. It should be noted that an annular space is reliably produced between the front cover 2 and the fluid actuation chamber 3 within the fluid chamber.

It should be noted that a resin member 10 is disposed between the inner peripheral part of the front cover 2 and the cylindrical portion 53a of the turbine hub 53, and a first port 11 is formed in the resin member 10 for allowing the operating oil to flow back and forth in the radial direction. An oil path disposed within the input shaft and the space between the turbine 5 and the front cover 2 are communicated through the first port 11. On the other hand, a first thrust bearing 12 is disposed between the turbine hub 53 and the inner peripheral part of the stator 6, and a second port 13 is formed in the first thrust bearing 12 for allowing the operating oil to flow back and forth in the radial direction. Further, a second thrust bearing 14 is disposed axially between the stator 6 and the impeller 4, and a third port 15 is formed in the second thrust bearing 14 for allowing the operating oil to flow back and forth in the radial direction. The respective ports 11, 13 and 15 can independently supply and discharge the operating oil.

[Structure of Lock-Up Device]

The lock-up device 7 is a device for transmitting torque from the crankshaft of the engine and for absorbing and attenuating torsional vibration. As illustrated in FIG. 1, the lock-up device 7 is a mechanism disposed in the space between the turbine 5 and the front cover 2 for mechanically coupling the both elements on an as-needed basis. The lock-up device 7 is disposed in a space A produced axially between the front cover 2 and the turbine 5. The lock-up device 7 is disposed for roughly axially dividing the space A. Here, the space between the front cover 2 and the lock-up device 7 is defined as a first hydraulic chamber B, while the space between the lock-up device 7 and the turbine 5 is defined as a second hydraulic chamber C.

The lock-up device 7 has a function of a clutch and that of an elastic coupling mechanism, and mainly includes a piston 71, a retaining plate 72, a driven plate 73 as an output rotary member, a plurality of large torsion springs 74 (first coil springs), a plurality of small torsion springs 75 (second coil springs) and a support member 76.

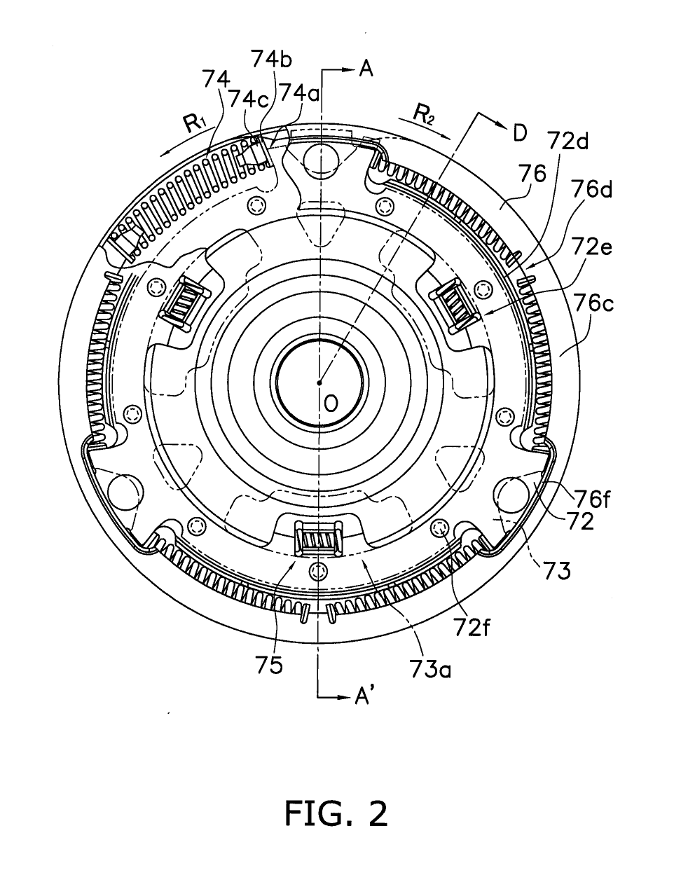

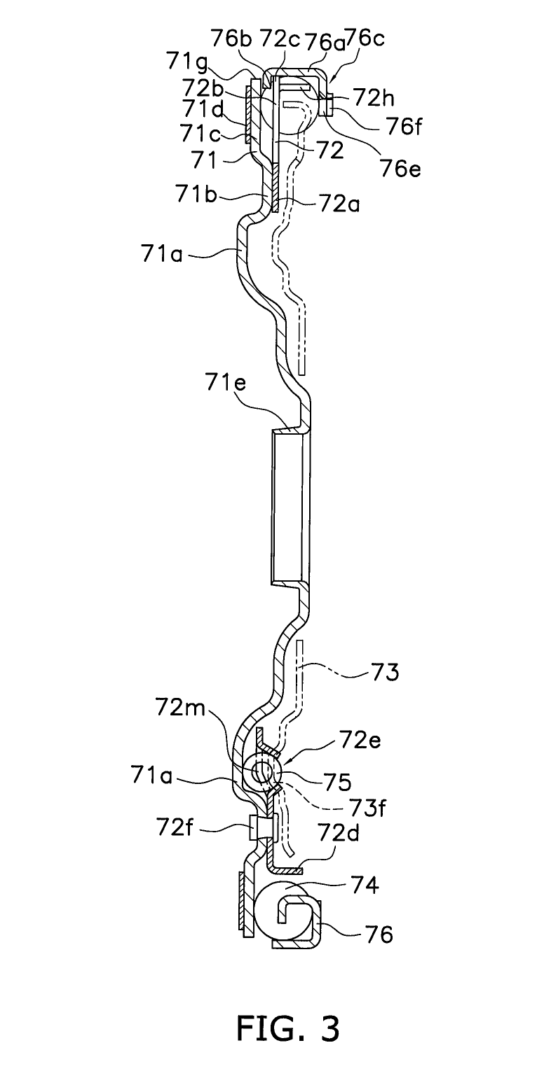

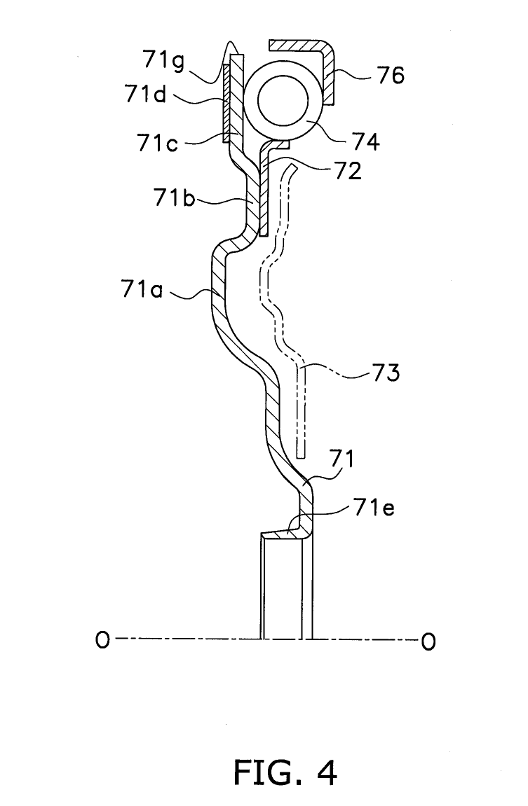

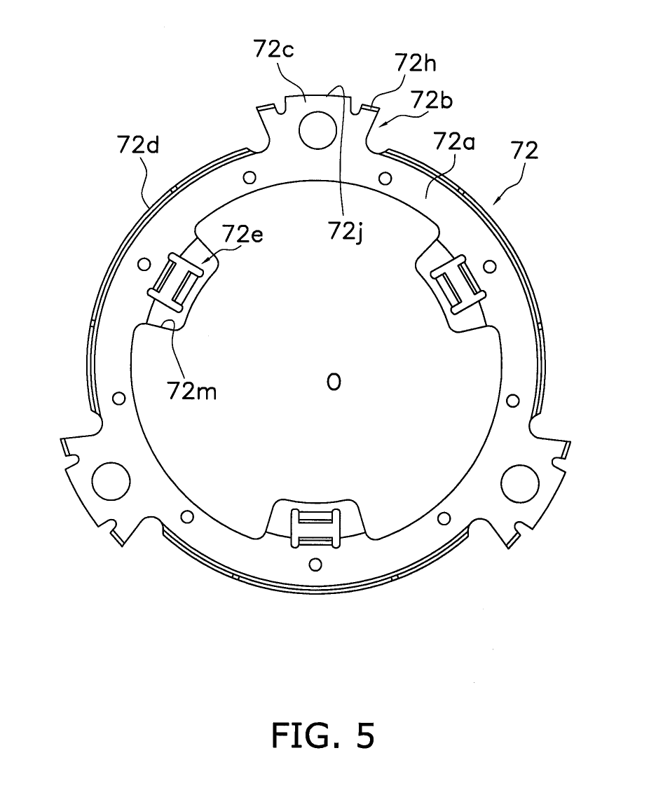

Here, FIG. 2 is a plan view of the lock-up device 7 seen from the transmission side. On the other hand, FIG. 3 is a diagram of an A-A′ cross section in FIG. 2, whereas FIG. 4 is a diagram of an O-D cross section in FIG. 2. Further, FIG. 5 is a plan view of the retaining plate 72.

The piston 71 is a member for coupling and decoupling the clutch, and further, functions as an input member in the lock-up device 7 as an elastic coupling mechanism. The piston 71 is disposed while being rotatable with respect to the crankshaft of the engine. The piston 71 is a disc-shaped member having a circular hole in the center thereof. An outer lateral end 71g (see FIG. 3) of the piston 71 is extended to the outer peripheral edge of the retaining plate 72, i.e., the outer peripheral edges of outer peripheral side protruding portions 72c to be described.

The piston 71 is radially extended inside the space A for roughly axially dividing the space A. As illustrated in FIGS. 3 and 4, the piston 71 has a recessed portion 71a curved towards the engine on a roughly radial center part thereof. As illustrated in FIG. 3, small torsion springs 75 are partially disposed in the recessed portion 71a.

Further, the piston 71 has: a dent portion 71b formed on the outer peripheral side of the recessed portion 71a while being curved towards the transmission; and a flat portion 71c formed on the further outer peripheral side of the dent portion 71b while being perpendicular to the axial direction. A friction facing 71d is disposed on the engine side surface of the flat portion 71c. Here, a flat portion 2a is formed in the front cover 2. The flat portion 2a of the front cover 2 is a portion opposed to the friction facing 71d of the piston 71. A clutch function of the lock-up device 7 is implemented by the flat portion 2a of the front cover 2, the flat portion 71c of the piston and the friction facing 71d of the piston 71.

The piston 71 has an inner peripheral side tubular portion 71e that is formed on the inner peripheral edge thereof while being radially extended towards the engine. The inner peripheral side tubular portion 71e is supported by the outer peripheral surface of the turbine hub 53. It should be noted that the piston 71 is axially movable and contactable with the front cover 2. Further, an annular seal ring 71f, which makes contact with the inner peripheral surface of the inner peripheral side tubular portion 71e, is disposed on the outer peripheral part of the turbine hub 53 (see FIG. 1). Axial sealing is achieved by the seal ring 71f at the inner peripheral edge of the piston 71.

As illustrated in FIGS. 2 and 3, the retaining plate 72 is an annular member, and also, a member made of metal. Further, the retaining plate 72 has a fixation portion 72a, three support portions 72b, the outer peripheral side protruding portions 72c (radial support portion), rotation restricting portions 72d, spring accommodating portions 72e and circumferential support portions 72m.

The fixation portion 72a is a portion formed in a roughly annular shape and is fixed to the dent portion 71b of the piston 71 by a plurality of rivets 72f (see FIG. 3). The support portions 72b are portions for supporting circumferential ends of the large torsion springs 74. Further, the support portions 72b are protruded from the fixation portion 72a to the outer peripheral side while being integrally formed with the fixation portion 72a. Further, the support portions 72b are disposed at predetermined intervals in the circumferential direction.

The support portion 72b has plate-shaped circumferential support portions 72h (outer peripheral side circumferential support portion 72h) extended towards the transmission on the both circumferential ends of the outer peripheral part thereof. The outer peripheral side circumferential support portion 72h is allowed to make contact with a circumferential end of the large torsion spring 74. The outer peripheral side protruding portion 72c is a portion protruded to the further outer peripheral side from the support portion 72b. The outer peripheral side protruding portion 72c is disposed between two large torsion springs 74 circumferentially adjacent to each other.

The rotation restricting portions 72d are portions for restricting the retaining plate 72 and the driven plate 73 from rotating relatively to each other by making contact with the driven plate 73. The rotation restricting portion 72d is formed in a plate shape while being protruded towards the transmission from the outer peripheral edge of the fixation portion 72a in the center part between the support portions 72b circumferentially adjacent to each other. The rotation restricting portion 72d is contactable with the driven plate 73 at the both circumferential ends thereof.

The spring accommodating portions 72e are portions allowed to accommodate the small torsion springs 75, and are disposed while being protruded from the fixation portion 72a to the inner peripheral side. Further, the spring accommodating portion 72e has another circumferential support portions 72m (the inner peripheral side circumferential support portions 72m) formed on the inner peripheral side of the outer peripheral side circumferential support portions 72h. The inner peripheral side circumferential support portion 72m is contactable with a circumferential end of the small torsion spring 75.

The driven plate 73 is an annular member made of sheet metal. The inner peripheral part of the driven plate 73 is fixed to the turbine hub 53 by the plural rivets 55. Further, three window holes 73a are formed in the roughly radial center part of the driven plate 73 for disposing therein the small torsion springs 75. Circumferential support portions 73b (outer peripheral side circumferential support portions 73b), which are bent towards the engine, are formed on the outer peripheral end portion of the driven plate 73. Further, circumferential support portions 73f (inner peripheral side circumferential support portions 73f), which are curved towards the engine, are formed on the radially center part of the driven plate 73, i.e., on the inner peripheral side of the outer peripheral side circumferential support portions 73b.

The outer peripheral side circumferential support portion 73b is contactable with a circumferential end of the large torsion spring 74. Further, two large torsion springs 74 of each pair are compressed between the circumferential support portions 73b of the driven plate 73 and between the outer peripheral side circumferential support portions 72h of the retaining plate 72. The inner peripheral side circumferential support portion 73f is contactable with a circumferential end of the small torsion spring 75. Further, each of the plural small torsion springs 75 is compressed between the circumferential support portions 73f of the driven plate 73 and between the inner peripheral side circumferential support portions 72m of the retaining plate 72.

Further, flat plate shaped portions 73c are formed in the driven plate 73. When the flat plate shaped portions 73c then make contact with the rotation restricting portions 72d, rotation of the driven plate 73 is restricted. It should be noted that rotary restricting means is formed by the aforementioned rotation restricting portions 72d of the retaining plate 72 and the flat plate shaped portions 73c of the driven plate 73.

The large torsion springs 74 transmit power between the piston 71 and the driven plate 73 through the retaining plate 72. Further, the large torsion springs 74 absorb and attenuate torsion vibration. The large torsion springs 74 are disposed on the transmission side of the piston 71. Further, in the present exemplary embodiment, three pairs (three units) of the large torsion springs 74 (six large torsion springs 74) are disposed while being aligned in the circumferential direction. A pair of the large torsion springs 74 is formed by two large torsion springs 74. As illustrated in FIG. 2, spring sheets 74a are disposed on the both circumferential ends of the large torsion spring 74. The spring sheet 74a is supported by the retaining plate 72, and has: a disc-shaped portion 74b for supporting a circumferential end of the large torsion spring 74; and a protruding support portion 74c protruded from the disc-shaped portion 74b in the circumferential direction.

The small torsion springs 75 transmit power between the retaining plate 72 and the driven plate 73. Further, the small torsion springs 75 absorb and attenuate torsional vibration. The small torsion springs 75 are disposed on the inner peripheral side of the large torsion springs 74. The small torsion springs 75 are disposed on the transmission side of the piston 71. Here, there small torsion springs 75 are disposed while being aligned in the circumferential direction. Further, each of the three small torsion springs 75 is compressed in collaboration with a pair of large torsion springs 74. A basic torsion characteristic of the lock-up device 7 is formed by the compression.

The support member 76 is a member for supporting the outer peripheral side of the large torsion springs 74. Further, the support member 76 has an outer peripheral side support portion 76a, three protruding portions 76b, movement restricting portions 76c and intermediate portions 76d.

The outer peripheral side support portion 76a is a portion for supporting the outer peripheral side of the large torsion springs 74, and is disposed on the outer peripheral side of the large torsion springs 74 as illustrated in FIG. 3. Further, the outer peripheral side support portion 76a is a cylindrical portion extended along the axial direction. Yet further, the outer peripheral side support portion 76a is radially supported by the tips of the outer peripheral side protruding portions 72c of the retaining plate 72. The outer peripheral side support portion 76a is disposed on the axially transmission side of the outer peripheral side protruding portions 72c.

The protruding portions 76b are disposed on the engine side end of the outer peripheral side support portion 76a while being protruded to the inner peripheral side from the inner peripheral surface of the outer peripheral side support portion 76a. The protruding portions 76b are disposed at equal intervals in the circumferential direction. Further, as illustrated in FIG. 3, the protruding portions 76b are portions disposed axially between the outer lateral end 71g of the piston 71 and outer peripheral edges 72j of the retaining plate 72. When the support member 76 tries to axially move towards the transmission, the protruding portions 76b make contact with the engine side surface of the outer peripheral side protruding portions 72c and the support member 76 is thereby restricted from moving. Further, when the support member 76 tries to axially move towards the engine, the protruding portions 76b make contact with the transmission side surface of the outer lateral end 71g of the piston 71 and the support member 76 is thereby restricted from moving towards the engine. The protruding portions 76b are disposed correspondingly to the outer peripheral side protruding portions 72c. In other words, the protruding portions 76b are disposed in positions where no large torsion spring 74 is disposed in the circumferential direction.

The moving restricting portions 76c are portions for restricting the large torsion springs 74 from moving towards the transmission, and are extended to the inner peripheral side from the transmission side end of the outer peripheral side support portion 76a. Further, the moving restricting portion 76c has a restriction section 76e and a reinforcement section 76f. The restriction section 76e is a section for restricting movement of the large torsion springs 74 by making contact with the large torsion springs 74 when the large torsion springs 74 try to move towards the transmission. The restriction section 76e is a section extended to the inner peripheral side form the transmission side end of the outer peripheral side support portion 76a. It should be noted that the axial interval between the moving restricting portions 76c and the piston 71 is greater than the diameter of the large torsion springs 74 while the protruding portions 76b make contact with the retaining plate 72. In other words, a clearance is formed between the moving restricting portions 76c and the large torsion springs 74. The reinforcement section 76f is a section for enhancing the strength of the moving restricting portion 76c, and is extended towards the transmission from the restriction section 76e.

As illustrated in FIG. 2, the intermediate portions 76d are portions allowed to support the circumferential ends of the large torsion springs 74, and are respectively disposed circumferentially between every adjacent two large torsion springs 74. Further, the intermediate portions 76d are portions extended towards the engine from the moving restricting portions 76c.

[Actions of Torque Converter]

Immediately after the start of the engine, the operating oil is supplied into the main body of the torque converter 1 through the first port 11 and the third port 15 while being discharged through the second port 13. The operating oil supplied through the first port 11 flows through the space (the first hydraulic chamber B) between the piston 71 and the front cover 2 to the outer peripheral side, flows through the space (the second hydraulic chamber C) between the piston 71 and the turbine 5, and flows into the fluid actuation chamber 3.

Further, the operating oil, supplied into the main body of the torque converter 1 through the third port 15, is moved towards the impeller 4 and is moved towards the turbine 5 by the impeller 4. Yet further, the operating oil moved towards the turbine 5 is moved towards the stator 6 by the turbine 5, and is again supplied to the impeller 4. The turbine 5 is rotated by the actions.

Power transmitted to the turbine 5 is transmitted to the input shaft. Thus, power is transmitted between the crankshaft of the engine and the input shaft. It should be noted that the piston 71 is herein separated away from the front cover 2, and thereby, torque of the front cover 2 is not transmitted to the piston 71.

[Actions of Lock-Up Device]

When the rotational speed of the torque converter 1 is increased and that of the input shaft reaches a predetermined level, the operating oil in the first hydraulic chamber B is discharged through the first port 11. As a result, by the hydraulic difference between the first hydraulic chamber B and the second hydraulic chamber C, the piston 71 is moved towards the front cover 2 and the friction facing 71d is pressed onto the flat friction surface of the front cover 2. When the friction facing 71d is pressed onto the front cover 2, torque of the front cover 2 is transmitted from the piston 71 to the driven plate 73 through the retaining plate 72 and the large torsion springs 74. Further, the torque transmitted to the driven plate 73 is transmitted from the driven plate 73 to the turbine 5. In other words, the front cover 2 is mechanically coupled to the turbine 5 and the torque of the front cover 2 is directly outputted to the input shaft through the turbine 5.

[Torsional Characteristic of Lock-Up Device]

In the aforementioned lock-up coupled state, the lock-up device 7 transmits torque. The lock-up device 7 not only transmits torque but also absorbs and attenuates torsional vibration to be inputted thereto from the front cover 2 based on a torsional characteristic.

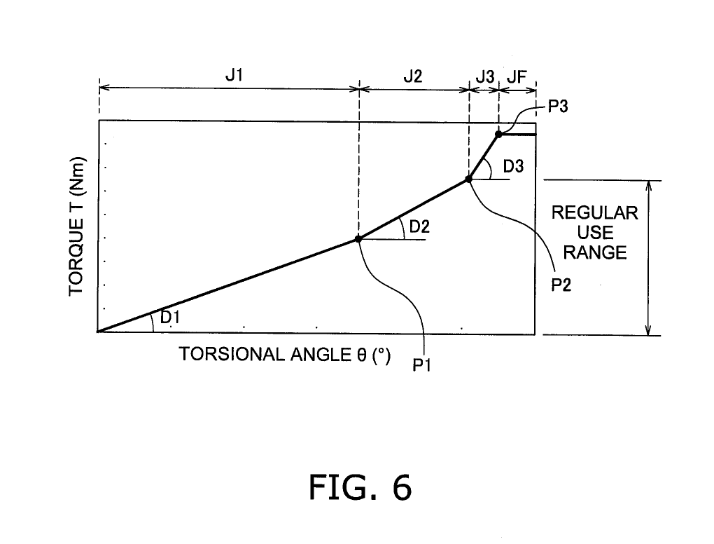

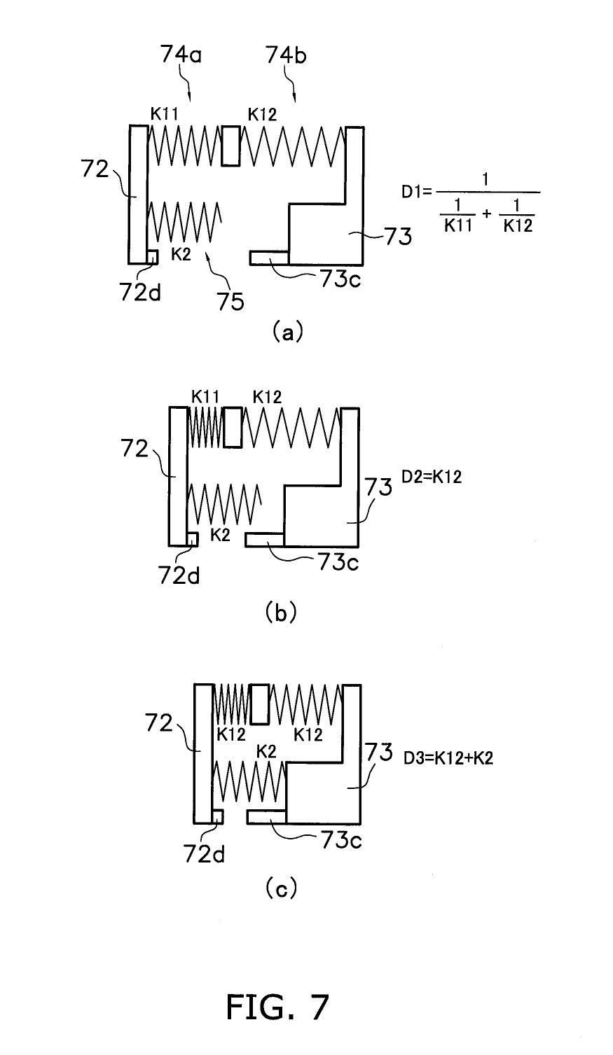

The torsional characteristic of the lock-up device 7 will be hereinafter explained using FIGS. 6 and 7. FIG. 6 is a model diagram representing a three stage torsional characteristic of the lock-up device 7, whereas FIG. 7 is a model diagram where the torsion springs are compressed in the lock-up device 7. Further, FIGS. 6 and 7 are model diagrams where a pair of the large torsion springs 74 and a single small torsion spring 75 are compressed.

It should be noted that in FIG. 7, for the purpose of distinguishing between a pair of the large torsion springs 74, i.e., two large torsion springs 74, a reference numeral 74a is assigned to one of the two large torsion springs 74 while a reference numeral 74b is assigned to the other of the two large torsion springs 74.

Specifically, when torsional vibration is inputted into the lock-up device 7 from the front cover 2, a torsional angle θ is produced between the retaining plate 72 and the driven plate 73. Accordingly, as illustrated in FIG. 7(a), the two large torsion springs 74a and 74b of each pair are rotation-directionally compressed between the retaining plate 72 and the driven plate 73. Specifically, the two large torsion springs 74a and 74b of each pair are rotation-directionally compressed between the outer peripheral side circumferential support portions 72h of the retaining plate 72 and between the circumferential support portion 73b of the driven plate 73. The state is referred to as a first compressed state J1 (see FIG. 6). In the first compressed state J1, a first stage torsional characteristic is determined by the torsional stiffness obtained by merging the torsional stiffnesses of the two large torsion springs 74a and 74b, i.e., a first torsional stiffness D1. Then, torsional vibration is absorbed and attenuated based on the first stage torsional characteristic.

When the torsional angle θ is increased under the condition, the large torsion spring 74a, which is one of the two large torsion springs 74 of each pair, becomes incompressible while the coiled portions thereof are closely contacted to each other. The condition at this time corresponds to a first bent point P1 in FIG. 6. When the aforementioned large torsion spring 74a is herein compressed while the coiled portions thereof are closely contacted to each other, as illustrated in FIG. 7(b), the large torsion spring 74b, which is the other of the two large torsion springs 74a and 74b of each pair, is rotation-directionally compressed between the retaining plate 72 and the driven plate 73, i.e., between the outer peripheral side circumferential support portions 72h of the retaining plate 72 and between the circumferential support portion 73b of the driven plate 73. The state is referred to as a second compressed state J2 (see FIG. 6). In the second compressed state J2, a second stage torsional characteristic is determined by the torsional stiffness of the single large torsion spring 74b, i.e., a second torsional stiffness D2. Then, torsional vibration is absorbed and attenuated based on the second stage torsional characteristic.

When the torsional angle θ is further increased under the condition, compression of the plural small torsion springs 75 is started under a condition that the large torsion springs 74a, which are the ones of the respective pairs, are compressed while the coiled portions thereof are closely contacted to each other, whereas the large torsion springs 74b, which are the others of the respective pairs, are compressed. The condition at this time corresponds to a second bent point P2 in FIG. 6. Further, as illustrated in FIG. 7(c), the plural small torsion springs 75 and the large torsion springs 74b, which are the others of the respective pairs, are compressed between the retaining plate 72 and the driven plate 73. When described in detail, the large torsion springs 74b, which are the others of the respective pairs, are rotation-directionally compressed between the outer peripheral side circumferential support portions 72h of the retaining plate 72 and between the circumferential support portions 73b of the driven plate 73. Further, the plural small torsion springs 75 are rotation-directionally compressed between the inner peripheral side circumferential support portions 72m of the retaining plate 72 and between the inner peripheral side circumferential support portions 73f of the driven plate 73. The state is referred to as a third compressed state J3 (see FIG. 6). In the third compressed state J3, a third stage torsional characteristic is determined by the torsional stiffness obtained by merging the torsional stiffness of the single large torsion spring 74 and that of the single small torsion spring 75, i.e., a third torsional stiffness D3. Then, torsional vibration is absorbed and attenuated based on the third stage torsional characteristic.

When the torsional angle θ is further increased under the condition, the rotation restricting portions 72d of the retaining plate 72 finally make contact with the flat plate shaped portions 73c of the driven plate 73. The condition corresponds to a condition at a threshold P3 in FIG. 6. Then, compression of the large torsion springs 74 of the respective pairs in motion and that of the small torsion springs 75 of in motion are stopped. The state is referred to as a compression stopped state JF (see FIG. 6). In other words, the damper actions of the torsion springs 74 and 75 are stopped.

[Torsional Characteristic of Lock-Up Device]

With reference to FIGS. 6 and 7, explanation will be hereinafter made for the torsional stiffness where the torsion springs 74 and 75 are actuated as described above. It should be herein noted that explanation will be made using the torsional stiffness of each of the paired large torsion springs 74 and the torsional stiffness of the single small torsion spring 75 for the sake of easy explanation. It should be noted that reference numerals K11 and K12 are assigned to the torsional stiffnesses of the two large torsion springs 74 while a reference numeral K2 will be assigned to the torsional stiffness of the single small torsion spring 75.

As represented and illustrated in FIGS. 6 and 7, in the first compressed state J1, the torsional stiffness of the two large torsion springs 74 disposed in series is set as the first torsional stiffness D1 (=1/{(1/K11+1/K12)}. Next, when one of the large torsion springs 74 is compressed while the coiled portions thereof are closely contacted to each other and thus the first compressed state J1 is shifted to the second compressed state J2, the torsional stiffness K12 of the compressible one of the large torsion springs 74 is set as the second torsional stiffness D2 (=K12) in the second compressed state J2. The torsional characteristic is herein set so that a ratio of the second torsional stiffness D2 with respect to the first torsional stiffness D1 can fall within a predetermined range, for instance, a range of greater than or equal to 1.5 and less than or equal to 3.0.

Subsequently, when compression of the small torsion spring 75 is started while one of the large torsion springs 74 is compressed and thus the second compressed state J2 is shifted to the third compressed state J3, the torsional stiffness of the parallel disposed large torsion springs 74 and small torsion spring 75 is set as the third torsional stiffness D3 (=K12+K2). Thus, the three stage torsional characteristic is set. Finally, when the third compressed state J3 is shifted to the compression stopped state JF, the torsional angle θ of the torsional characteristic reaches the maximum torsional angle θ. Where the torsional angle θ reaches the maximum torsional angle θ, torque becomes the maximum torque in the torsional characteristic.

It should be noted that in the torsional characteristic herein described, the first stage and the second stage of the torsional characteristic are used as the torsional characteristic in a regular use range. Therefore, in the aforementioned content, only the stiffness ratio of the second torsional stiffness D2 with respect to the first torsional stiffness D1 is set to fall within a predetermined range while the stiffness ratio of the third torsional stiffness D3 with respect to the second torsional stiffness D2 is not particularly required to be set to fall within a predetermined range, for instance, a range of greater than or equal to 1.5 and less than or equal to 3.0 or a range of greater than or equal to 2.0 and less than or equal to 2.5.

[Advantageous Effects of Torsional Vibration Attenuating Characteristic]

As described above, in the present lock-up device 7, the torsional characteristic can be set to have multiple stages, i.e., three stages.

By thus setting the torsional characteristic to have three stages, the torsional stiffnesses D1, D2 and D3, varying in accordance with the torsional angle θ, can be gradually increased without being acutely changed even when the target reduction amount of torque variation is increased. Accordingly, it is possible to inhibit initial vibration that could be generated when the torsional angle θ is small. Further, in the present lock-up device 7, the stiffness ratio of the N-th torsional stiffness and the (N+1)-th torsional stiffness (i.e., the stiffness ratio of the (N+1)-th torsional stiffness with respect to the N-th torsional stiffness; N is a positive integer) is set to be greater than or equal to 1.5 and less than or equal to 3.0 in the regular use range. Therefore, it is possible to inhibit vibration that could be generated when a bent point of the torsional characteristic is exceeded, i.e., vibration attributed to stiffness difference. Especially, where the stiffness ratio of the (N+1)-th torsional stiffness with respect to the N-th torsional stiffness is set to be greater than or equal to 2.0 and less than or equal to 2.5 in the regular use range, it is possible to reliably inhibit vibration attributed to stiffness difference, which could be produced when a bent point of the torsional characteristic is exceeded. Thus, the present lock-up device 7 can reliably inhibit vibration attributed to variation in stiffness of the torsion springs.

Further, in the present lock-up device 7, the second torsional stiffness D2 is produced by compressing either of the paired two large coil springs 74 so that the coiled portions thereof are closely contacted to each other. Subsequently, the third torsional stiffness D3 is produced by compressing the other of the paired two large coil springs 74 and the small coil spring 75. Accordingly, a three stage torsional characteristic can be obtained without specially preparing coil springs other than the aforementioned large coil springs 74 and small coil springs 75. In other words, the three stage torsional characteristic can be easily obtained without complicating the lock-up device 7.

Further, the relative rotation of the retaining plate 72 and the driven plate 73 is restricted by the rotary restricting means formed by the rotation restricting portions 72d of the retaining plate 72 and the flat plate shaped portions 73c of the driven plate 73. Accordingly, the action (damper action) for absorbing and attenuating the torsional vibration by the large torsion springs 74 and the small torsion springs 75 is stopped. In other words, the upper limit of the torsional characteristic is set by the rotary restricting means. By thus setting the upper limit of the torsional characteristic using the rotary restricting means, torque can be reliably transmitted from the retaining plate 72 to the driven plate 73 when the torsional angle becomes greater than or equal to a predetermined value.

### Other Exemplary Embodiments

(a) In the aforementioned exemplary embodiment, the case has been exemplified that the lock-up device 7 has the three stage torsional characteristic. However, the torsional characteristic is not limited to have three stages, and can be arbitrarily set. In short, advantageous effects similar to the aforementioned advantageous effects of the present invention can be achieved as long as the torsional characteristic is multi-staged.
(b) In the aforementioned exemplary embodiment, the case has been exemplified that the torsional characteristic is three-staged and the first stage and the second stage of the torsional characteristic are used in the regular use range. However, the torsional characteristic can have four or more stages and the remaining stages except for the final stage can be configured to be used in the regular use range. In this case, the ratio of adjacent torsional stiffnesses, i.e., the stiffness ratio of the (N+1)-th torsional stiffness with respect to the N-th torsional stiffness is set to be greater than or equal to 1.5 and less than or equal to 3.0, or alternatively, greater than or equal to 2.0 and less than or equal to 2.5, in the remaining torsional stiffnesses other than the torsional stiffness of the final stage. Even in this case, advantageous effects similar to the aforementioned ones can be obtained.

### INDUSTRIAL APPLICABILITY

The present invention can be utilized for a lock-up device of a torque converter for transmitting torque and for absorbing and attenuating torsional vibration.

1. A lock-up device for a torque converter for transmitting torque and for absorbing and attenuating torsional vibration, the lock-up device comprising:
an input rotary member;
an output rotary member; and
a pair of first coil springs configured on a radially outer side to be compressed in a rotation direction by relative rotation between the input rotary member and the output rotary member, the pair of first coil springs being adjacent to each other in the rotation direction, the pair of first coil being arranged to act in series; and
a second coil spring configured on a radially inner side to be compressed in the rotation direction by the relative rotation between the inner rotary member and the outer rotary member when a relative angle of the relative rotation is equal to or greater than a predetermined relative angle,
a stiffness ratio between an N-th torsional stiffness and an (N+1)-th torsional stiffness being set to be greater than or equal to 1.5 and less than or equal to 3.0 in a multistage torsional characteristic of representing a relation between the relative angle and the torque, the multistage torsional characteristic being produced by compressing at least any one of the two first coil springs and the second coil spring in accordance with the relative angle between the input rotary member and the output rotary member.

2. The lock-up device for a torque converter recited in claim 1, wherein
the stiffness ratio between the N-th torsional stiffness and the (N+1)-th torsional stiffness in the torsional characteristic is set to be greater than or equal to 2.0 and less than or equal to 2.5.

3. The lock-up device for a torque converter recited in claim 1, wherein
in the multistage torsional characteristic excluding the final stage of the torsional characteristic, a stiffness ratio between the N-th torsional stiffness and the (N+1)-th torsional stiffness is set to be the stiffness ratio.

4. The lock-up device for a torque converter recited in claim 3, wherein
the multistage torsional characteristic is a three stage torsional characteristic, and
a ratio of the first rotational stiffness and the second rotational stiffness is set to be the stiffness ratio,
the first rotational stiffness is produced when the two first coil springs are compressed,
the second torsional stiffness is produced when one of the first coil springs is compressed, while the other of the first coil springs is fully compressed.

5. The lock-up device for a torque converter recited in claim 4, wherein
the relative angle produced when the one of the first coil springs is compressed and when the other of the first coil springs is fully compressed is less than the predetermined relative angle produced when compression of the second coil spring is started.

6. The lock-up device for a torque converter recited in claim 1, further comprising:
rotation restricting means for restricting the relative rotation between the input rotary member and the output rotary member.
